(19) United States
(12) Patent Application Publication
(10) Pub. No.: US 2013/0300127 A1
(43) Pub. Date: Nov. 14, 2013

(54) Geothermal energy recovery from abandoned oil wells

(71) Applicant: Arthur Robert DiNicolantonio, El Lago, TX (US)

(72) Inventor: Arthur Robert DiNicolantonio, El Lago, TX (US)

(21) Appl. No.: 13/468,879

(22) Filed: May 10, 2012

(51) Int. Cl. F03G 7/04; H02K 7/18

(52) U.S. Cl. 290/1 R; 60/641.2

(57) ABSTRACT

A method and apparatus for recovering geothermal heat from abandoned sub sea oil wells and converting it to electricity which is then transmitted via cable to an onshore station for distribution to the electric grid. To accomplish this we insert a unique heat transfer recovery pipe into the well bore of these dormant oil wells and transfer the heat from the oil/brine and rocks surrounding these wells and the oil and brine in the lower portion of these wells to a continuous stream of a fluid such as water which is pumped through the heat transfer pipe to a vessel located on the ocean floor or on a water surface platform. This hot fluid will be continuously pumped to a heat exchanger to exchange heat to another heat transfer gas which will drive a turbine. The turbine will drive a generator to produce electricity.

### FIELD OF THE INVENTION

The present invention relates to a method and apparatus for recovering geothermal heat from abandoned sub sea oil wells and converting it to electricity which is then transmitted via cable to an onshore station for distribution to the electric grid. Another application of this invention is that our system with it's down hole heat transfer pipe is directly applicable to on shore abandoned oil wells.

### BACKGROUND OF THE INVENTION

Currently there are hundreds of capped and or capped and abandoned oil wells in the Gulf of Mexico off the coast of Texas, Louisiana Mississippi, Alabama, and Florida. These wells range in depth of 3000 Meters to 5500 meters below the ocean floor. Virgin rock temperatures at 3000 meters are 212 Deg F and increase to 338 degrees F. at 5000 meters. The Department of Conservation, Division of Oil, Gas, and Geothermal Resources estimates that there are approximately six hundred wells scheduled to be abandoned each year in the Gulf of Mexico.

There are several ocean thermal energy conversion plants and or systems in existence today. They are located on the surface of the water and recover heat by pumping cold water from the ocean floor which is at 36 degrees F. and hot surface water at 80 F using the temperature difference to condense and evaporate a heat transfer liquid/gas which is fed to a turbine and electric generator. One Ocean thermal energy conversion plant built in 1993 in Keahole Point Hawaii produced 50 KWh of electricity. In 1981 a plant built in Nauru Japan by Tokyo Electric Power Company produced 100 KWh electricity. In 1999 the Natural Energy Laboratory tested a closed cycle pilot plant that produced 250 KWh. Our proposed system can produce 2500 KWh from each abandoned well and there are typically 6 to 8 wells in close proximity. Therefore we can generate 10 to 80 times more energy than any ocean thermal energy conversion plant.

### SUMMARY OF THE INVENTION

The present invention is method and apparatus for recovering geothermal heat from abandoned sub sea oil wells and converting it to electricity which is then transmitted via cable to an onshore station for distribution to the electric grid. To accomplish this we insert a unique heat transfer recovery pipe into the well bore of these dormant oil wells and transfer the heat from the oil/brine, sand, and rocks surrounding and in these wells to a fluid such as water which is continuously pumped through the heat transfer pipe to a vessel located on the ocean floor or on a water surface platform or tethered vessel.

U.S. Pat. No. 5,095,707 describes a system which intermittently pumps water into the well hole well in order to create a vacuum to drive a turbine. In our system this hot fluid will be pumped to an exchanger to exchange heat to another heat transfer liquid/gas which will be fed to a turbine. The turbine will drive a generator to produce electricity which will either be linked to the cables of surrounding systems and cabled to an onshore station for distribution to the electric grid or cabled by itself to an onshore station for distribution to the electric grid.

U.S. Pat. No. 3,911,683 describes a system in which a passive heat pipe is inserted into a well bore but in contrast to our system the upper end extends into a chamber where the down hole water is heated to it's saturation point is converted into steam to drive a turbine. We do not generate steam with our down hole fluid and our down hole fluid is not at its saturation temperature.

U.S. Pat. No. 5,183,100 relies on a pump to circulate the down heat transfer fluid but requires either the pump or the inlet to the pump to extended below the water level in it's down hole riser pipe. We do locate either our pump or it's inlet below the water level in the riser pipe.

U.S. Pat. No. 4,776,169 describes a system for injecting two heat transfer fluids into a well bore where as we only inject one fluid.

U.S. Pat. No. 3,857,244 relies on an exchanger located in the lower section of the well bore. The exchanger vaporizes a heat transfer fluid. We do not have an exchanger in the lower portion of the well bore and we do not necessarily vaporize any of our down hole heat transfer fluid

Depending on the depth and diameter of the abandoned well bore our system can produce 2500 KWh from typical 14 inch diameter well 5000 meters deep. There are typically 6 to 8 wells in close proximity. Therefore we can produce 17500 KWh at each location. This is a significant increase in electric power production compared to other existing technologies. The energy produced from our system is directly proportional to the diameter of the well bore. Another application of this invention is that with it's down hole heat transfer pipe is directly applicable to on shore abandoned oil wells.

The Technology and Processes Involved with this Invention Meets DOE Mission:

(i) it makes the U.S. less dependent on foreign oil

(ii) it is a green project producing no emissions and no environmental impacts

(iii) it reduces the technology & time related to locating viable heat source drilling locations since offshore drilled hole temperatures are well documented and can be analyzed to optimize core temperature availability

(iv) it saves the oil companies money by saving the expense of plugging the oil wells scheduled for abandonment, and Since there are hundreds of well holes already drilled, geothermal site drilling costs are reduced

(v) it answers the challenge of developing new techniques to reduce thermal core drilling costs

(vi) it minimizes drilling impacts relative to core & surface disruption, visibility, and population impact since this new concept involving utilization of existing core penetrations, sub sea productions systems, and a single cable interface to the shore minimizes all top-side environmental concerns

### DRAWINGS

FIG. 1 is a typical flow plan of the system of this invention

FIG. 2 A is a cross sectional view of the down hole heat transfer pipe of claims 4, 5, 8, and 9

FIG. 2 B shows cross section A-A and B-B of the down hole pipe shown in FIG. 2A.

### DETAILED DESCRIPTION OF THE PREFERRED EMBODIMENTS OF THE INVENTION

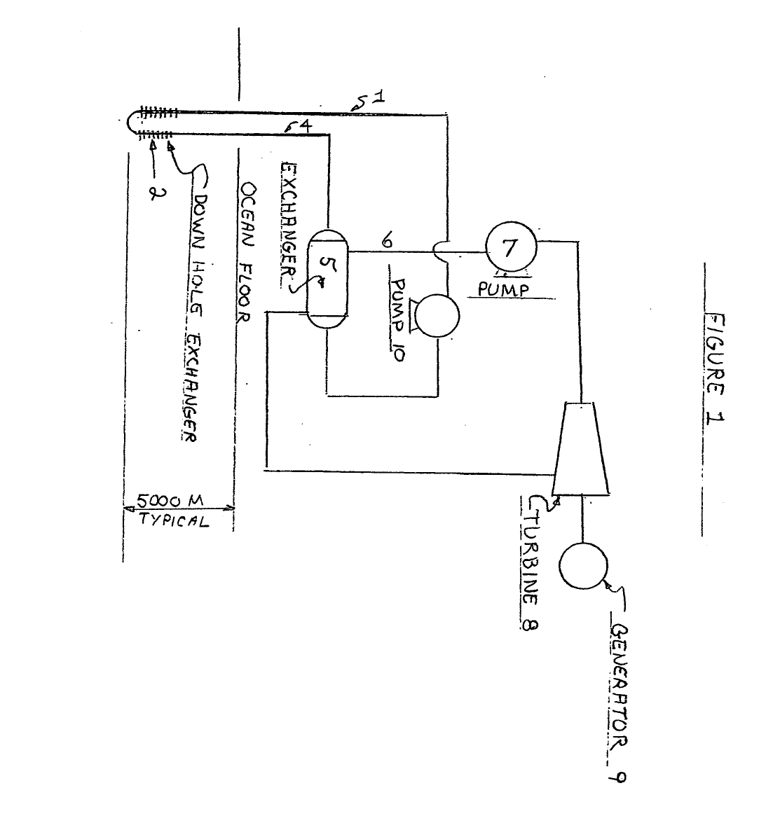

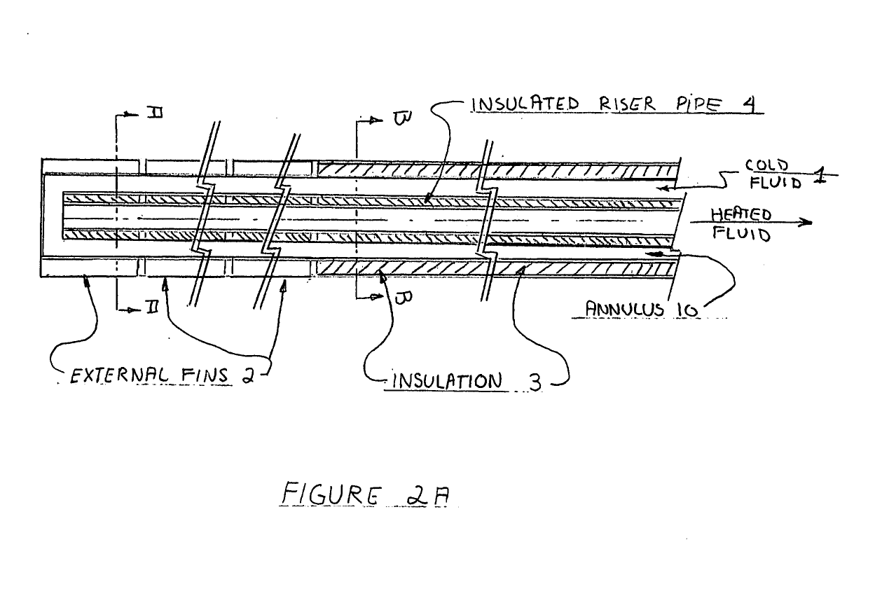

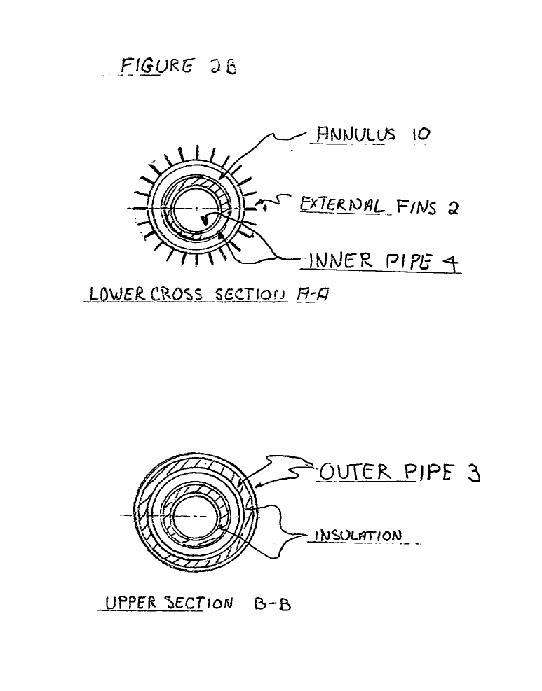

FIG. 1 shows the flow plan for geothermal energy production from a 5000 meter deep oil well with a 14 inch diameter well hole bore. The heat transferred, energy produced, flow rates, pump energy consumption shown in this figure are directly proportional to the well bore diameter. The apparatus of this example produces a net energy of 25,000 KWH. Referring to this figure cold water 1 at 195 F is pumped down the down hole pipe which has fins 2 (see FIGS. 1, 2A and 2B) on the lowest 1500 meter long section of this pipe. The upper 3500 meters of this pipe 3 is externally insulated (see FIG. 2A). The heated heat transfer fluid which in this example is potable water is returned to through the riser pipe 4 at 265 F to a heat exchanger 5. The preferred embodiment of this down corner pipe and riser pipe is shown in FIG. 2A and 2B and is claimed in claims 3 and 8. Claim 4 uses the same design but the cold heat transfer fluid is pumped down the inner pipe 4 and the heated heat transfer is returned to the exchanger by being pumped through the annulus between the inner and outer pipe. The 265 F heat transfer fluid is passed through an exchanger 5 where it's temperature is dropped to 195 F by transferring heat to another heat transfer gas 6 which in this example is propane gas at 191 F and 70 psia. 2568272 lbs /hr propane is heated to 200 F and then pumped up to 160 psia. The polytropic pump raises the temperature to 235 F. The propane at 160 psia and 235 F is fed to a turbine 8 where it produces 13844 KWh energy and drops in temperature to 191F and 70 psia. The turbine drives an electric generator 9 which produces 13428 KWH electricity. 10,908 KWH of this energy (approximately 81%) is used to power the electric motors for the down hole water pump and the pump which raised the propane from 60 psi to 160 psi.

The down hole fluid is not limited to potable water as used in this example but may be any other liquid fluid or fluid which may or may not be vaporized by the down hole heat. A fluid that is vaporized by the down hole heat would decrease the head in the riser pipe and lower the pumping energy required to circulate this heat transfer fluid. Additionally the flow of this fluid in not limited to counter current as shown in this example but may be concurrent. In countercurrent flow the cold fluid would be pumped down the annulus shown in the heat transfer device shown in FIGS. 2A and 2B and the heated fluid flows up the inner pipe. In co current flow the cold fluid is pumped down the inner pipe 4 of the heat transfer device shown in FIGS. 2A and 2 B and the heated fluid flows up the annulus. The heat transfer gas which powers the turbine is not limited to propane but may be any other gas or liquid/gas which is more energy efficient.

The insulation shown in FIGS. 2 A and 2 B may be a castable, ceramic fiber, or foam insulation. Also the number and length of fins may be significantly more than 48 or less and the length of fins may be more or less than the 1500 meters shown. The fin orientation may be either longitudinal as shown or circumferential. The fins may also be located internal to the outer heat transfer pipe. The diameter of the outer and inner pipe may be optimized to fit the well bore size.

What is claimed:

1. Inserting a heat transfer pipe containing a heat transfer fluid into an abandoned oil well for the purpose of recovering heat from the hot rocks, sand, oil and hot brine surrounding and in the lower portion of the abandoned well.

2. Pumping this hot fluid to an exchanger located on the ocean floor or on a water surface platform or tethered vessel where it is exchanged with another fluid/gas which drives a turbine. This turbine drives a generator which produces electricity which is either connected to cables of nearby stations or cabled by itself to an onshore station for distribution to an electric grid.

3. The design of the down hole heat transfer pipe consisting of two concentric pipes. The lower portion of the outer pipe has either longitudinal fins or circumferential fins to enhance it's heat transfer with the hot rocks, oil, sand and brine at the deepest portion of the well and the upper portion is jacketed with insulation to minimize the loss of heat from the hotter fluid to the lower temperature rocks, sand, oil and brine surrounding the well closer to the sea floor. The inner pipe is a conduit for the hot heat transfer fluid while the colder heat transfer fluid passes in the upper portion of the annulus. The inner pipe is insulated to prevent heat loss from the hot fluid in inner pipe to the cooler fluid in the surround annulus in the upper portion of the annulus near the sea floor.

4. The design of the down hole heat transfer pipe consisting of two concentric pipes. The lower portion of the outer pipe has either longitudinal fins or circumferential fins to enhance it's heat transfer from the hot oil, rocks, sand and brine at the deepest portion of the well and the upper portion is jacketed with insulation to minimize the loss of hot fluid in the annulus to the colder temperature rocks, sand, oil and brine closer to the sea floor. The inner pipe is a conduit for the cold heat transfer fluid while the hot heat transfer fluid passes through the annulus of the outer pipe and the inner pipe. The inner pipe is insulated to minimize the loss of heat from the hot fluid in the annulus to the cold fluid in the inner pipe.

5. The design of the down hole heat transfer pipe consisting of two pipes connected with a “U” bend at the bottom of the well bore. The lower portion of one or both pipes have either longitudinal fins or circumferential fins and the upper portion of both pipes is jacketed with insulation. One of the pipes is a conduit for the cold heat transfer fluid while the adjacent pipe is a conduit for the hot heat transfer fluid.

6. The design of the down hole heat transfer pipe that utilizes the well bore casing itself as the outer heat transfer pipe. A smaller diameter concentric pipe is inserted in the upper section of the well bore and the annulus between this pipe and the upper section of the well bore casing is filled with insulation. A smaller diameter insulated riser pipe is inserted in the center of the well bore. The cold heat transfer fluid is pumped through the annulus of the smaller bore insulated center riser pipe and upper insulated portion of the well bore pipe casing and then pumped through the annuls of lower un insulated well bore casing and the central insulated riser pipe. After being heated by the hot rocks, sand, oil and brine surrounding and in the lower portion of the well bore casing the heated heat transfer fluid is pumped up through the insulated riser pipe which is centrally located in the well bore.

7. An exchanger located on the sea floor or on a surface platform or tethered vessel for exchanging heat from the hot down hole heat transfer fluid to another liquid/gas which can be used to drive a turbine which drives an electric generator. The flow of the heat transfer is continuous and it's friction loss over come by a pump either on the sea floor or on the sea surface.

8. The method of claim 1 where the down hole heat recovery pipe is inserted into a onshore abandoned oil well and the hot heat transfer fluid is pumped to a surface station containing the pumps, heat exchanger, turbine, and generator.

9. The design of the down hole heat transfer pipe of claim 3, 4, or 8 is inserted into an abandoned on shore oil well. This down hole heat transfer pipe consists of two concentric pipes. The lower portion of the outer pipe has either longitudinal fins or circumferential fins to enhance its heat pickup from the hot oil sand and rocks at the deepest portion of the well and the upper portion is jacketed with insulation to minimize heat loss from the hot heat transfer fluid to the colder sand and rocks surrounding the upper portion of the well. The inner pipe is insulated to minimize heat transfer from its fluid to the fluid in the annulus.

10. The design of the abandoned onshore well down hole heat transfer pipe of claim 5 consisting of two pipes connected with a “U” bend at the bottom of the well bore. The lower portion of one or both pipes have either longitudinal fins or circumferential fins to enhance it's heat pickup and the upper portion of both pipes is jacketed with insulation to minimize its heat loss. One of the pipes is a conduit for the cold heat transfer fluid while the adjacent pipe is a conduit for the hot heat transfer fluid.
